(19) United States
(12) Patent Application Publication
(10) Pub. No.: US 2022/0174957 A1
(43) Pub. Date: Jun. 9, 2022

(54) PESTICIDAL COMPOSITIONS

(71) Applicant: SYNGENTA CROP PROTECTION AG, Basel (CH)

(72) Inventors: Christian POPP, Munchwilen (CH); Anke BUCHHOLZ, Stein (CH); Werner REINER, Stein (CH); Fabienne HATT, Basel (CH); Daniel SCHNEIDER, Munchwilen (CH)

(73) Assignee: SYNGENTA CROP PROTECTION AG, Basel (CH)

(21) Appl. No.: 17/594,227

(22) PCT Filed: Apr. 8, 2020
(86) PCT No.: PCT/EP2020/060076

§ 371 Date: Oct. 7, 2021

(30) Foreign Application Priority Data
Apr. 10, 2019 (EP) 19168504.9

(51) Int. Cl. A01N 43/90; A01N 43/38; A01P 7/04

(52) U.S. Cl. CPC A01N 43/90; A01P 7/04; A01N 43/38

(57) ABSTRACT

A pesticidal composition comprising: (i) A compound of Formula (I) active ingredient, wherein: A is hydrogen or methyl; U is independently chloro or methyl; n is 1 or 2; G is hydrogen or —C(═O)OCH₂CH₃; and X is N or C(H); or an agrochemically acceptable salt thereof; and (ii) an adjuvant combination comprising: (a) an oxirane/methyl oxirane block co-polymer (polyoxyethylene/polyoxypropylene block copolymer); and (b) an alcohol alkoxylate; wherein the weight ratio of component (a) to component (b) is 1:3 to 3:1; and the weight ratio of component (i) to (ii) is 1:1 to 1:4.

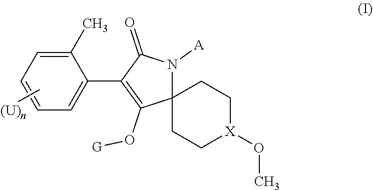

The present invention relates to a suspension concentrate composition comprising an insecticidal active ingredient, to the preparation thereof and to a method of using such a composition to control pests in crops of useful plants.

A pesticide adjuvant may be defined as a substance present in a pesticide spray formulation, either incorporated into an active ingredient concentrate (ie, the so-called “built-in” adjuvant) which is diluted in a spray tank prior to spraying, or is added to a spray tank prior to spraying and is not a component of the active ingredient concentrate (ie, the so-called “tank-mix” adjuvant), which improves pesticidal active ingredient performance, for example by facilitating the spreading of the active ingredient on a leaf surface or penetration into the leaf. The use of built-in adjuvants in an agrochemical formulation may simplify the spraying process by eliminating the step of separate addition of an adjuvant to the spray tank, and so in certain circumstances might be preferred.

WO 2004/007448 and WO 2010/066780 disclose that certain spiroheterocyclic pyrrolidine dione derivatives have pesticidal activity, in particular, insecticidal, acaricidal, molluscicidal and nematicidal activity. Such derivatives function systemically and upon foliar application are able to penetrate into a plant leaf and move through the plant's vascular system. For this reason, these derivatives are, in particular, effective against insect sucking pests, such as aphids, thrips and whiteflies. However, it is important when applying to a plant a composition comprising such derivatives to strike a balance between achieving acceptable pesticidal efficacy whilst limiting phytotoxic outcomes, which may result from excessive penetration of the active ingredient into the plant.

Thus, there remains a motivation in the development of agrochemical formulations, in particular those comprising a built-in adjuvant, for novel compositions which meet these dual requirements of an optimised pesticidal (insecticidal) efficacy, whilst limiting phytotoxicity and thus significant damage to a plant (crop safety).

According to the present invention, there is provided a pesticidal composition comprising:

(i) a compound of Formula (I) as active ingredient:

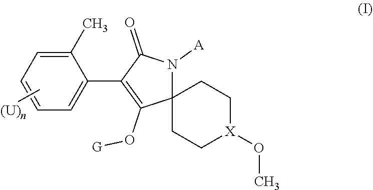

wherein:
A is hydrogen or methyl;
U is independently chloro or methyl;
n is 1 or 2;
G is hydrogen or —C(═O)OCH₂CH₃; and
X is N or C(H);

or an agrochemically acceptable salt thereof; and

(ii) an adjuvant combination comprising:
(a) an oxirane/methyl oxirane block co-polymer (polyoxyethylene/polyoxypropylene block copolymer); and
(b) an alcohol alkoxylate;

wherein the weight ratio of component (a) to component (b) is 1:3 to 3:1; and

the weight ratio of component (i) to (ii) is 1:1 to 1:4.

Surprisingly, it has been found that the compositions of the invention, have for practical purposes, a very advantageous level of activity in controlling insect pests in crops of useful plants after foliar or soil application, whilst also maintaining acceptable crop safety (phytotoxicity) outcomes. By activity, it is meant that the compositions of the invention are capable of killing or controlling insects, retarding the growth or reproduction of insects, reducing an insect population, and/or reducing damage to plants caused by insects.

In a second aspect of the invention, there is provided a method of combating and controlling pests which comprises applying to a pest, to a locus of a pest, or to a crop of a useful plant susceptible to attack by a pest a composition according to the invention.

In a third aspect of the invention, there is provided a method of controlling pests, which method comprises applying to the soil of a crop of a useful plant a composition according to according to the invention, wherein the application is by drip, drenching or injection to the soil.

Preferably, the composition according to the invention is a suspension concentrate formulation. Suspension concentrate (SC) formulations are stable suspensions of a solid pesticidal active ingredient(s) in a fluid usually intended for dilution before use. Ideally, the suspension should be stable (i.e., not settle out). Suspension concentrate formulations are generally diluted with water prior to customary spraying via nozzles and besides the active ingredient(s), may also contain also other auxiliaries, such as surfactants, emulsifiers, dispersants, wetting agents, antifreeze agents, antifoaming agents, biocides, solvents, stabilizers, anti-microbials, pigments, buffers, surface-active substances, etc. Such substances will be known to the person skilled in the art of agrochemical formulation. Suspension concentrate formulations may be prepared by ball or bead milling the solid active ingredient compound in a suitable medium, optionally with one or more dispersing agents, to produce a fine particle suspension of the compound. One or more wetting agents may be included in the composition and a suspending (anti-settling) agent may be included to reduce the rate at which the particles settle. Alternatively, the active ingredient may be dry milled and added to water, containing agents hereinbefore described, to produce the desired end product.

Preferably, the compound of Formula (I) (component (i)) is selected from one of compound 1 (spiropidion—CAS no.: 1229023-00-0) or compound 2 (spirotetramat—CAS no.: 203313-25-1), and most preferably compound 1 (spiropidion).

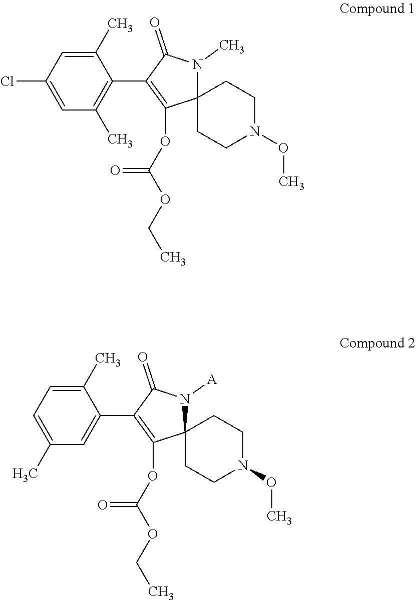

Component (ii) is an adjuvant combination comprising: (a) an oxirane/methyl oxirane block co-polymer (polyoxyethylene/polyoxypropylene block copolymer); and (b) an alcohol alkoxylate.

The oxirane/methyl oxirane block co-polymer used as component (a) of the adjuvant combination (ii) preferably has a molecular mass in the range of 2500 to 7000 g/mol, and more preferably 4000 to 6000 g/mol. Preferably, this oxirane/methyl oxirane block co-polymer comprises a central polyoxypropylene group (block) flanked by two polyoxyethylene groups (blocks). That is, the oxirane/methyl oxirane block co-polymer comprises a POE-POP-POE sequence, wherein POE represents a polyoxyethylene (—CH₂CH₂O—) block and POP (—CH₂CH(CH₃)O—) represents a polyoxypropylene block, and has a molecular mass (g/mol) of 2500 to 7000.

In one embodiment of the invention, the oxirane/methyl oxirane block co-polymer used as component (a) of the adjuvant combination (ii) is of the general formula:

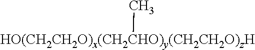

wherein x is an integer in the range of 10 to 15, y is an integer in the range of 25 to 35, and z is an integer in the range of 10 to 15, preferably wherein the block co-polymer has a molecular mass (g/mol) in the range of 2500 to 3500 g/mol.

In another embodiment of the invention, the oxirane/methyl oxirane block co-polymer used as component (a) of the adjuvant combination (ii) is of the general formula:

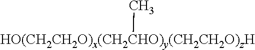

wherein x is an integer in the range of 30 to 40, y is an integer in the range of 50 to 60, and z is an integer in the range of 30 to 40, preferably wherein the block co-polymer has a molecular mass (g/mol) in the range of 6000 to 7000 g/mol.

Examples of oxirane/methyl oxirane block co-polymers which may be used in accordance with the present invention are Pluronic® PE 6400 (BASF Corporation, USA) and Pluronic® PE 10500 (BASF Corporation, USA).

The alcohol alkoxylate used as component (b) of the adjuvant combination (ii) is preferably an alkoxylated C₁₂ to C₁₅ fatty alcohol, and more preferably, an ethoxylated and/or propoxylated C₁₂ to C₁₅ fatty alcohol. An example of an alkoxylated C₁₂ to C₁₅ fatty alcohol is Plurafac® LF 404 (BASF Corporation, USA).

The weight ratio of component (a) to component (b) is 1:3 to 3:1. This may include the specific weight ratios of component (a) to component (b) of 1:3, 1:2, 2:3, 1:1, 3:2, 2:1 or 3:1. Preferably, the weight ratio of component (a) to component (b) is 1:1 to 3:1, and more preferably, 1:1 to 2:1, in particular 1.5:1.

The weight ratio of component (i) to (ii) is 1:1 to 1:4. This may include the specific weight ratios of component (i) to component (ii) of 1:1, 2:3, 1:2, 2:5, 1:3, 2:7 or 1:4. Preferably, the weight ratio of component (i) to component (ii) is 1:2 to 1:4, and more preferably, 1:2 to 1:3, in particular 2:5.

Preferably, treatments applying the composition of the present invention are as the sole pesticidal active ingredient being the compound of formula (I), however, the compositions may also be applied in combination with one or more additional pesticidal (insecticidal, acaracidal or nematicidal) active ingredients or active ingredient compositions, eg, in a tank mix.

Examples of pests which may be controlled in accordance with the present invention include those:

from the order Acarina, for example, Acalitus spp, Aculus spp, Acaricalus spp, Aceria spp, Acarus siro, Amblyomma spp., Argas spp., Boophilus spp., Brevipalpus spp., Bryobia spp, Calipitrimerus spp., Chorioptes spp., Dermanyssus gaffinae, Dermatophagoides spp, Eotetranychus spp, Eriophyes spp., Hemitarsonemus spp, Hyalomma spp., Ixodes spp., Olygonychus spp, Ornithodoros spp., Polyphagotarsone latus, Panonychus spp., Phyllocoptruta oleivora, Phytonemus spp, Polyphagotarsonemus spp, Psoroptes spp., Rhipicephalus spp., Rhizoglyphus spp., Sarcoptes spp., Steneotarsonemus spp, Tarsonemus spp. and Tetranychus spp.;

from the order Anoplura, for example, Haematopinus spp., Linognathus spp., Pediculus spp., Pemphigus spp. and Phylloxera spp.;

from the order Coleoptera, for example, Agriotes spp., Amphimallon majale, Anomala orientalis, Anthonomus spp., Aphodius spp, Astylus atromaculatus, Ataenius spp, Atomaria linearis, Chaetocnema tibialis, Cerotoma spp, Conoderus spp, Cosmopolites spp., Cotinis nitida, Curculio spp., Cyclocephala spp, Dermestes spp., Diabrotica spp., Diloboderus abderus, Epilachna spp., Eremnus spp., Heteronychus arator, Hypothenemus hampei, Lagria vilosa, Leptinotarsa decemLineata, Lissorhoptrus spp., Lyogenys spp, Maecolaspis spp, Maladera castanea, Megascelis spp, Melighetes aeneus, Melolontha spp., Myochrous armatus, Orycaephilus spp., Otiorhynchus spp., Phyllophaga spp, Phlyctinus spp., Popiffia spp., Psyffiodes spp., Rhyssomatus aubtilis, Rhizopertha spp., Scarabeidae, Sitophilus spp., Sitotroga spp., Somaticus spp, Sphenophorus spp, Sternechus subsignatus, Tenebrio spp., Tribolium spp. and Trogoderma spp.;

from the order Diptera, for example, Aedes spp., Anopheles spp, Antherigona soccata, Bactrocea oleae, Bibio hortulanus, Bradysia spp, Calliphora erythrocephala, Ceratitis spp., Chrysomyia spp., Culex spp., Cuterebra spp., Dacus spp., Delia spp, Drosophila melanogaster, Fannia spp., Gastrophilus spp., Geomyza tripunctata, Glossina spp., Hypoderma spp., Hyppobosca spp., Liriomyza spp., Lucilia spp., Melanagromyza spp., Musca spp., Oestrus spp., Orseolia spp., OscineIla frit, Pegomyia hyoscyami, Phorbia spp., Rhagoletis spp, Rivelia quadrifasciata, Scatella spp, Sciara spp., Stomoxys spp., Tabanus spp., Tannia spp. and Tipula spp.;

from the order Hemiptera, for example, Acanthocoris scabrator, Acrosternum spp, Adelphocoris lineolatus, Amblypelta nitida, Bathycoelia thalassina, Blissus spp, Cimex spp., Clavigralla tomentosicoffis, Creontiades spp, Distantiella theobroma, Dichelops furcatus, Dysdercus spp., Edessa spp, Euchistus spp., Eurydema pulchrum, Eurygaster spp., Halyomorpha halys, Horcias nobilellus, Leptocorisa spp., Lygus spp, Margarodes spp, Murgantia histrionic, Neomegalotomus spp, Nesidiocoris tenuis, Nezara spp., Nysius simulans, Oebalus insularis, Piesma spp., Piezodorus spp, Rhodnius spp., Sahlbergella singularis, Scaptocoris castanea, Scotinophara spp., Thyanta spp, Triatoma spp., and Vatiga illudens;

from the order Homoptera, for example, Acyrthosium pisum, Adalges spp, Agalliana ensigera, Agonoscena targionii, Aleurodicus spp, Aleurocanthus spp, Aleurolobus barodensis, Aleurothrixus floccosus, Aleyrodes brassicae, Amarasca biguttula, Amritodus atkinsoni, Aonidiella spp., Aonidiella auranti, Aphididae, Aphis spp., Aspidiotus spp., Aulacorthum solani, Bactericera cockerelli, Bemisia spp, Brachycaudus spp, Brevicoryne brassicae, Cacopsylla spp, Cavariella aegopodii Scop., Ceroplaster spp., Chrysomphalus aonidium, Chrysomphalus dictyospermi, Cicadella spp, Cofana spectra, Cryptomyzus spp, Cicadulina spp, Coccus hesperidum, Dalbulus maidis, Dialeurodes spp, Diaphorina citri, Diuraphis noxia, Dysaphis spp, Empoasca spp., Eriosoma larigerum, Erythroneura spp., Gascardia spp., Glycaspis brimblecombei, Hyadaphis pseudobrassicae, Hyalopterus spp, Hyperomyzus pallidus, Idioscopus clypealis, Jacobiasca lybica, Laodelphax spp., Lecanium corni, Lepidosaphes spp., Lopaphis erysimi, Lyogenys maidis, Macrosiphum spp., Mahanarva spp, Metcalfa pruinosa, Metopolophium dirhodum, Myndus crudus, Myzus spp., Neotoxoptera sp, Nephotettix spp., Nilaparvata spp., Nippolachnus piri Mats, Odonaspis ruthae, Oregma lanigera Zehnter, Parabemisia myricae, Paratrioza cockereffi, Parlatoria spp., Pemphigus spp., Peregrinus maidis, Perkinsiella spp, Phorodon humuli, Phylloxera spp, Planococcus spp., Pseudaulacaspis spp., Pseudococcus spp., Pseudatomoscelis seriatus, Psylla spp., Pulvinaria aethiopica, Quadraspidiotus spp., Quesada gigas, Recilia dorsalis, Rhopalosiphum spp., Saissetia spp., Scaphoideus spp., Schizaphis spp., Sitobion spp., Sogatella furcifera, Spissistilus festinus, Tarophagus Proserpina, Toxoptera spp, Trialeurodes spp, Tridiscus sporoboli, Trionymus spp, Trioza erytreae, Unaspis citri, Zygina flammigera, and Zyginidia scutellaris;

from the order Hymenoptera, for example, Acromyrmex, Arge spp, Atta spp., Cephus spp., Diprion spp., Diprionidae, Gilpinia polytoma, Hoplocampa spp., Lasius spp., Monomorium pharaonis, Neodiprion spp., Pogonomyrmex spp, Slenopsis invicta, Solenopsis spp. and Vespa spp.;

from the order Isoptera, for example, Coptotermes spp, Corniternes cumulans, Incisitermes spp, Macrotermes spp, Mastotermes spp, Microtermes spp, Reticulitermes spp.; Solenopsis geminate;

from the order Lepidoptera, for example, Acleris spp., Adoxophyes spp., Aegeria spp., Agrotis spp., Alabama argillaceae, Amylois spp., Anticarsia gemmatalis, Archips spp., Argyresthia spp, Argyrotaenia spp., Autographa spp., Bucculatrix thurberiella, Busseola fusca, Cadra cautella, Carposina nipponensis, Chilo spp., Choristoneura spp., Chrysoteuchia topiaria, Clysia ambiguella, Cnaphalocrocis spp., Cnephasia spp., Cochylis spp., Coleophora spp., Colias lesbia, Cosmophila flava, Crambus spp, Crocidolomia binotalis, Cryptophlebia leucotreta, Cydalima perspectalis, Cydia spp., Diaphania perspectalis, Diatraea spp., Diparopsis castanea, Earias spp., Eldana saccharina, Ephestia spp., Epinotia spp, Estigmene acrea, Etiella zinckinella, Eucosma spp., Eupoecilia ambiguella, Euproctis spp., Euxoa spp., Feltia jaculiferia, Grapholita spp., Hedya nubiferana, Heliothis spp., Hellula undalis, Herpetogramma spp, Hyphantria cunea, Keiferia lycopersicella, Lasmopalpus lignosellus, Leucoptera scitella, Lithocollethis spp., Lobesia botrana, Loxostege bifidalis, Lymantria spp., Lyonetia spp., Malacosoma spp., Mamestra brassicae, Manduca sexta, Mythimna spp, Noctua spp, Operophtera spp., Orniodes indica, Ostrinia nubilalis, Pammene spp., Pandemis spp., Panolis flammea, Papaipema nebris, Pectinophora gossypiela, Perileucoptera coffeella, Pseudaletia unipuncta, Phthorimaea operculella, Pieris rapae, Pieris spp., Plutella xylostella, Prays spp., Pseudoplusia spp, Rachiplusia nu, Richia albicosta, Scirpophaga spp., Sesamia spp., Sparganothis spp., Spodoptera spp., Sylepta derogate, Synanthedon spp., Thaumetopoea spp., Tortrix spp., Trichoplusia ni, Tuta absoluta, and Yponomeuta spp.;

from the order Mallophaga, for example, Damalinea spp. and Trichodectes spp.;

from the order Orthoptera, for example, Blatta spp., Blattella spp., Gryllotalpa spp., Leucophaea maderae, Locusta spp., Neocurtilla hexadactyla, Periplaneta spp., Scapteriscus spp, and Schistocerca spp.;

from the order Psocoptera, for example, Liposcelis spp.;

from the order Siphonaptera, for example, Ceratophyllus spp., Ctenocephalides spp. and Xenopsylla cheopis;

from the order Thysanoptera, for example, Calliothrips phaseoli, Frankliniella spp., Heliothrips spp, Hercinothrips spp., Parthenothrips spp, Scirtothrips aurantii, Sericothrips variabilis, Taeniothrips spp., Thrips spp; and/or

from the order Thysanura, for example, Lepisma saccharina.

Examples of soil-inhabiting pests, which can damage a crop in the early stages of plant development, are:

from the order Lepidoptera, for example, Acleris spp., Aegeria spp., Agrotis spp., Alabama argillaceae, Amylois spp., Autographa spp., Busseola fusca, Cadra cautella, Chilo spp., Crocidolomia binotalis, Diatraea spp., Diparopsis castanea, Elasmopalpus spp., Heliothis spp., Mamestra brassicae, Phthorimaea operculella, Plutella xylostella, Scirpophaga spp., Sesamia spp., Spodoptera spp. and Tortrix spp.;

from the order Coleoptera, for example, Agriotes spp., Anthonomus spp., Atomaria linearis, Chaetocnema tibialis, Conotrachelus spp., Cosmopolites spp., Curculio spp., Dermestes spp., Diabrotica spp., Dilopoderus spp., Epilachna spp., Eremnus spp., Heteronychus spp., Lissorhoptrus spp., Melolontha spp., Orycaephilus spp., Otiorhynchus spp., Phlyctinus spp., Popillia spp., Psyffiodes spp., Rhizopertha spp., Scarabeidae, Sitotroga spp., Somaticus spp., Tanymecus spp., Tenebrio spp., Tribolium spp., Trogoderma spp. and Zabrus spp.;

from the order Orthoptera, for example, Gryllotalpa spp.;

from the order Isoptera, for example, Reticulitermes spp.;

from the order Psocoptera, for example, Liposcelis spp.;

from the order Anoplura, for example, Haematopinus spp., Linognathus spp., Pediculus spp., Pemphigus spp. and Phylloxera spp.;

from the order Homoptera, for example, Eriosoma larigerum;

from the order Hymenoptera, for example, Acromyrmex, Atta spp., Cephus spp., Lasius spp., Monomorium pharaonis, Neodiprion spp., Solenopsis spp. and Vespa spp.;

from the order Diptera, for example, Tipula spp.;

crucifer flea beetles (Phyllotreta spp.), root maggots (Delia spp.), cabbage seedpod weevil (Ceutorhynchus spp.) and aphids.

In particular, the compositions of the invention may be applied against insects from the order Homoptera (in particular, white flies, aphids, psyllids and armoured and soft scales), Thysanoptera (thrips), Acarina (mites) and Lepidoptera (butterflies and moths, and larva thereof). Preferably, the compositions of the invention may be applied against white flies, aphids, thrips.

Crops of useful plants in which the compositions according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, watermelon, okra, onion, leek, pepper, potato, pumpkin, squash, rhubarb, spinach and tomato; and vines for example grapes. The compositions of the invention can also be applied on turf, lawn and pastures.

Preferably, the compositions of the invention may be applied to a crop of a useful plant selected from:
the order Solanacea (including tomato, potato, aubergine, chilli, pepper, tobacco);
the order Cucurbitaceae (including squash, pumpkin, watermelon, melon, cucumber);
the order Alliaceae (including onion, garlic, leek);
the order Asparagacea (including asparagus).

Preferably, the compositions of the invention may be applied to a crop of a useful plant selected from cucumber, squash, pepper, melon, watermelon, tomato, aubergine, courgette or gourd.

The rate at which the agrochemical compositions of the invention are applied will depend upon the particular type of insect, etc, to be controlled, the degree of control required and the timing and method of application and can be readily determined by the person skilled in the art. In general, the compositions of the invention can be applied at an application rate of between 0.005 kilograms/hectare (kg/ha) and about 5.0 kg/ha, based on the total amount of active ingredient in the composition. An application rate of between about 0.1 kg/ha and about 1.5 kg/ha is preferred, with an application rate of between about 0.3 g/ha and 0.8 kg/ha being especially preferred.

Further other components that may be incorporated in the compositions of the present invention include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micro-nutrients, plasticisers, glidants, lubricants, dispersants, fillers, thickeners, antifreezes, microbicides, and liquid and solid fertilisers.

The compositions of the present invention when in an agrochemical formulation may possess any number of other benefits including, inter alia, the prevention of sedimentation, thickening, phase separation, cloudiness, foaming or crystal growth, improved chemical stability of the active ingredient (degradation), long-term formulation stability, or reduced clogging of spray nozzles during application and spray drift.

### EXAMPLES

The Examples which follow serve to illustrate the invention and demonstrate how various compositions comprising compound 1 (ie, spiropidion ([2-(4-chloro-2,6-dimethyl-phenyl)-8-methoxy-4-methyl-3-oxo-4,8-diazaspiro[4.5]dec-1-en-1-yl] ethyl carbonate)—CAS no.: 1229023-00-0) as active ingredient provide acceptable levels of insect control along with an acceptable crop safety profile relative to the presence of an adjuvant. Compound 1 may be prepared according to the procedures described in WO 2010/066780, WO 2018/114649 and WO 2018/114648.

The commercially-available adjuvants used in the compositions of the Examples are Pluronic® PE 6400 (BASF AG) and Pluronic® PE 10500 (BASF Corporation, USA) which are oxirane/methyl oxirane block co-polymers with a molecular mass (g/mol) in the range 2500 to 7000. Plurafac® LF 404 is a low-foaming non-ionic surfactant predominantly consisting of ethoxylated and propoxylated C₁₃ to C₁₅ alcohols (liquid at 23° C.).

Insecticidal activity and crop safety were tested on four weeks old Chinese cabbage (Brassica rapa) plants infested with green peach aphid (Myzus persicae). Plants were treated with a horizontal spray at described rates and incubated at 22° C., with a 14 hour light regime and ca. 60% relative humidity. Plants used for efficacy (activity) evaluations were infested with a mixed aged population of green peach aphid (Myzus persicae) two hours and six days after application. Plants used for crop safety evaluations were left uninfested and kept separately, but under identical environmental conditions. One and two weeks after application, the efficacy (i.e. aphid control relative to check) and crop safety (i.e., phytotoxicity relative to untreated) were assessed for each individual treatment. Each treatment was done in triplicate, i.e., three individual plants.

Compositions A-1 to I-1 were assessed for insecticidal activity against a spiropidion formulation applied at 50 g/ha active ingredient with rapeseed oil methyl ester (RME) EW40 as adjuvant at a weight ratio of 1:2 as a standard providing a score of 100 (an acceptable activity).

Compositions A-2 to I-2, which possess the same active ingredient to adjuvant weight ratios as formulations A-1 to I-1, were assessed for crop safety against a formulation applied at 100 g/ha active ingredient rapeseed oil methyl ester (RME) EW40 standard as adjuvant as standard providing a score of 100 (an acceptable crop safety).

The relative performance of formulations A-1 to I-1 (activity) and A-2 to I-2 (crop safety) was score rated against the respective standards based on the following:

A (−/−) rating was not considered acceptable for activity at the specified rate of active ingredient application, and a (−), (+) or (+/+) rating was considered acceptable.
−/− less than 90.
− 90-99.
+ 101-110.
+/+ greater than 110.

A (−/−) rating was not considered acceptable for crop safety at the specified rate of active ingredient application, and a (−), (+) or (+/+) rating was considered acceptable.
+/+ less than 90.
+ 90-99.
− 101-110.
−/− greater than 110.

TABLE 1

| | | | | Active | | |
|---|---|---|---|---|---|---|
| | | | | ingredient | | |
| | Active | | | (i): Adjuvant | | |
| | ingredient | Adjuvant | | ((a) & (b)) | Score | Score |
| Composition | (g/ha) | (g/ha) | | weight | for | for crop |
| no. | (i) | (a) | (b) | ratio | activity | safety |
| A-1 | 50 | 75 | − | 2:3 | −/− | |
| A-2 | 100 | 150 | − | 2:3 | | +/+ |
| B-1 | 50 | 75 | 25 | 2:3:1 | − | |
| B-2 | 100 | 150 | 50 | 2:3:1 | | +/+ |
| C-1 | 50 | 75 | 50 | 2:3:2 | + | |
| C-2 | 100 | 150 | 100 | 2:3:2 | | +/+ |
| D-1 | 50 | 100 | − | 1:2 | −/− | |
| D-2 | 100 | 200 | − | 1:2 | | +/+ |
| E-1 | 50 | 100 | 25 | 2:4:1 | −/− | |
| E-2 | 100 | 200 | 50 | 2:4:1 | | +/+ |
| F-1 | 50 | 100 | 50 | 1:2:1 | +/+ | |
| F-2 | 100 | 200 | 100 | 1:2:1 | | + |
| G-1 | 50 | 100 | − | 1:2 | +/+ | |
| G-2 | 100 | 200 | − | 1:2 | | −/− |
| H-1 | 50 | 100 | 25 | 2:4:1 | + | |
| H-2 | 100 | 200 | 50 | 2:4:1 | | −/− |
| I-1 | 50 | 75 | 50 | 2:3:2 | − | |
| I-2 | 100 | 150 | 100 | 2:3:2 | | +/+ |

For formulations A to F—The component (a) adjuvant is Pluronic® PE 6400.

For formulations G to I—The component (a) adjuvant is Pluronic® PE 10500.

The component (b) adjuvant (where present) is Plurafac® LF 404.

As can be seen from Table 1, only the compositions B, C, F and I with weight ratios between compound 1 and adjuvants (a) and (b) according to the invention did not score either an unacceptable (−/−) rating for insecticidal activity or an unacceptable (−/−) rating for crop safety against the standard formulation.

1. A pesticidal composition comprising:
(i) A compound of Formula (I) as active ingredient: 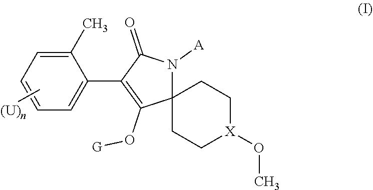
wherein:
A is hydrogen or methyl;
U is independently chloro or methyl;
n is 1 or 2;
G is hydrogen or —C(═O)OCH₂CH₃; and
X is N or C(H);
or an agrochemically acceptable salt thereof;
and
(ii) an adjuvant combination comprising components:
(a) an oxirane/methyl oxirane block co-polymer (polyoxyethylene/polyoxypropylene block copolymer); and
(b) an alcohol alkoxylate;
wherein the weight ratio of component (a) to component (b) is 1:3 to 3:1; and
the weight ratio of component (i) to (ii) is 1:1 to 1:4.

2. The composition according to claim 1, which is a suspension concentrate formulation.

3. The composition according to claim 1, wherein the compound of Formula (I) is spiropidion.

4. The composition according to claim 1, wherein the oxirane/methyl oxirane block co-polymer comprises a POE-POP-POE sequence, wherein POE represents a polyoxyethylene block and POP represents a polyoxypropylene block, wherein the co-polymer has a molecular mass (g/mol) of 2500 to 7000.

5. The composition according to claim 1, wherein the alcohol alkoxylate is an alkoxylated C₁₂ to C₁₅ fatty alcohol, preferably an ethoxylated and/or propoxylated C₁₂ to C₁₅ fatty alcohol.

6. The composition according to claim 1, wherein the weight ratio of component (a) to component (b) is 1:1 to 3:1.

7. The composition according to claim 1, wherein the weight ratio of component (i) to component (ii) is 1:2 to 1:3.

8. The composition according to claim 1, further comprising one or more additional ingredients selected from emulsifiers, dispersing agents, wetting agents, antifreeze agents, antifoaming agents, biocides, solvents, stabilizers, anti-microbial agents (biocide), pigments, buffers and fillers.

9. An aqueous diluted composition comprising the pesticidal composition according to claim 1.

10. A method of combating and controlling pests which comprises applying to a pest, to a locus of a pest, or to a crop of a useful plant susceptible to attack by a pest a composition according to claim 1.

11. A method of controlling pests, which method comprises applying to the soil of a crop of a useful plant a composition according to claim 1, wherein the application is by drip, drenching or injection to the soil.

12. The method according to claim 10, wherein the pest is selected from the order Homoptera, Thysanoptera, Acarina or Lepidoptera.

13. The method according to claim 12, wherein the pest is selected from white flies, aphids, thrips.

14. The method according to claim 10, wherein the plant is selected from the order Solanaceae, Cucurbitaceae, Alliaceae or Asparagacea.

15. The method according to claim 10, wherein the plant is selected from cucumber, squash, pepper, melon, watermelon, tomato, aubergine, courgette or gourd.
